(19) United States
(12) Patent Application Publication
(10) Pub. No.: US 2025/0077775 A1
(43) Pub. Date: Mar. 6, 2025

(54) UTILIZING MACHINE LEARNING MODELS TO GENERATE ASPECT-BASED TRANSCRIPT SUMMARIES

(71) Applicant: Adobe Inc., San Jose, CA (US)

(72) Inventors: Zhongfen Deng, Chicago, IL (US); Seunghyun Yoon, Seoul (KR); Trung Bui, San Jose, CA (US); Quan Tran, San Jose, CA (US); Franck Dernoncourt, Seattle, WA (US)

(21) Appl. No.: 18/457,794

(22) Filed: Aug. 29, 2023

(51) Int. Cl. G06F 40/284; G06F 40/166; G06N 20/00

(52) U.S. Cl. CPC G06F 40/284; G06F 40/166; G06N 20/00

(57) ABSTRACT

The present disclosure relates to systems, non-transitory computer-readable media, and methods for generating aspect-based summaries utilizing deep learning. In particular, in one or more embodiments, the disclosed systems access a transcript comprising sentences. The disclosed systems generate, utilizing a sentence classification machine learning model, aspect labels for the sentences of the transcript. The disclosed systems organize the sentences based on the aspect labels. The disclosed systems generate, utilizing a summary machine learning model, a summary of the transcript for each aspect of the plurality of aspects from the organized sentences.

### BACKGROUND

Recent years have seen significant improvements in generating summaries of content. For example, conventional systems generate summaries of documents to allow for quicker understanding of the documents. Often conventional systems generate ordered summaries. To illustrate, some conventional systems utilize existing ordering within a document to present summaries of the document. Although conventional systems are able to generate summaries, they have a number of technical and operational deficiencies.

### BRIEF SUMMARY

Embodiments of the present disclosure provide benefits and/or solve one or more of the foregoing or other problems in the art with systems, non-transitory computer-readable media, and methods for utilizing a sentence classification machine learning model and a summary machine learning model to generate aspect-based summaries of documents that summarize the various aspects in document. To illustrate, in one or more embodiments, the disclosed systems receive a document of sentences. Further, in some embodiments, the disclosed systems utilize a sentence classification machine learning model to determine aspect labels for the sentences. Additionally, in one or more embodiments, the disclosed systems organize and merge sentences based on the aspect labels. Accordingly, in some embodiments, the disclosed systems generate a summary of the transcript for each aspect label utilizing the summary machine learning model.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which an aspect-based summary system operates in accordance with one or more embodiments.

FIG. 2 illustrates an overview of the aspect-based summary system generating aspect-based summaries in accordance with one or more embodiments.

FIG. 3 illustrates training a sentence classification machine learning model in accordance with one or more embodiments.

FIG. 4 illustrates utilizing a trained sentence classification machine learning model and a trained summary machine learning model to generate aspect-based summaries in accordance with one or more embodiments.

FIG. 5 illustrates utilizing aspect-based summaries to generate a summary document in accordance with one or more embodiments.

FIG. 6 illustrates a schematic diagram of an aspect-based summary system in accordance with one or more embodiments.

FIG. 7 illustrates a flowchart of a series of acts for generating aspect-based summaries in accordance with one or more embodiments.

FIG. 8 illustrates a block diagram of an example computing device for implementing one or more embodiments of the present disclosure.

### DETAILED DESCRIPTION

This disclosure describes one or more embodiments of an aspect-based summary system that generates aspect-based summaries utilizing a sentence classification machine learning model and a summary machine learning model. More specifically, in one or more embodiments, the aspect-based summary system generates aspect labels for sentences from a transcript utilizing a sentence classification machine learning model. In some embodiments, the aspect-based summary system organizes the sentences based on the generated aspect labels. The aspect-based summary system utilizes a summary machine learning model to generate a summary of the transcript for each aspect label from the organized and labeled sentences.

As mentioned, in one or more embodiments, the aspect-based summary system utilizes a sentence classification machine learning model to generate aspect labels. To illustrate, in some embodiments, the aspect-based summary system provides sentences from a transcript to a trained sentence classification machine learning model. In one or more embodiments, the aspect-based summary system generates aspect labels, utilizing the sentence classification machine learning model, for each sentence in the transcript.

In some embodiments, the aspect-based summary system trains the sentence classification machine learning model is weakly supervised utilizing a training dataset of dialogue with pseudo-labelling. To illustrate, in some embodiments, the aspect-based summary system extracts meeting transcripts and corresponding summaries from a database of transcripts. Further, in one or more embodiments, the aspect-based summary system utilizes a language embedding model to generate embeddings for sentences in the extracted meeting transcripts. Accordingly, in one or more embodiments, the aspect-based summary system generates training aspect labels as pseudo-labels based on semantic similarities between sentences from the extracted transcripts and potential aspect labels. In some embodiments, the aspect-based summary system aggregates the sentences and corresponding training aspect labels to generate a training dataset for the sentence classification machine learning model.

Upon generating the aspect labels, in one or more embodiments, the aspect-based summary system organizes the sentences based on their corresponding aspect labels. More specifically, in some embodiments, the aspect-based summary system merges sentences with matching aspect labels utilizing an aspect token. Accordingly, in one or more embodiments, the aspect-based summary system generates a merged listing of sentences included in each determined aspect label.

Further, in some embodiments, the aspect-based summary system provides the organized sentences and aspect labels to a summary machine learning model. Additionally, in one or more embodiments, the summary machine learning model generates an aspect summary corresponding to each aspect label. Accordingly, in some embodiments, the aspect-based summary system combines the aspect summaries into a single document to generate an aspect-based summary of the transcript.

The aspect-based summary system provides many advantages and benefits over conventional systems and methods. For example, many conventional systems are inaccurate in their summary generation. These conventional systems often rely solely on order of appearance in an original transcript or other original document when determining ordering of a summary. This often leads to inaccurate summarization of topics from the document by leaving out detail from a later portion.

Additionally, many conventional systems are rigid and inflexible. As mentioned, conventional systems often rely solely on the original order of a transcript or document. However, this approach fails to adapt to the flow of most meeting transcripts, in which topics are often discussed out of order or in an alternating manner. Accordingly, the rigid approach of transcript order causes many conventional systems to yield summaries that are difficult to parse and fail to include all relevant information for various topics.

Additionally, the aspect-based summary system provides a single system (e.g., a single sentence classification model together with a single summary machine learning model) that produces a plurality of summaries for a given transcript. In particular, the aspect-based summary system generates a summary for each aspect in a transcript. This contrasts with conventional systems that require a separate model/system trained for each topic. Thus, the aspect-based summary system is more efficient than conventional systems because a single pipeline (e.g., a single sentence classification model together with a single summary machine learning model) produces a plurality of summaries rather than having to use multiple different pipelines to obtain a similar result. Thus, the aspect-based summary system utilizes fewer computing resources (storage and processing power) than conventional systems to generate the same type of result (e.g., multiple summaries for different topics/aspects in a document).

The aspect-based summary system provides improved accuracy in generating meeting transcripts. By training and utilizing a summary machine learning model, the aspect-based summary system is able to generate aspect labels accurately for each sentence in a transcript or other document. More specifically, the aspect-based summary system is able to generate accurate training data for the summary machine learning model utilizing a pseudo-labelling method for training transcripts that compares semantic similarities between transcripts and potential aspect labels utilizing a threshold. Thus, the aspect-based summary system trains the summary machine learning model to accurately and efficiently generate aspect labels for sentences from a transcript.

Further, the aspect-based summary system improves flexibility relative to conventional systems. More specifically, by utilizing aspect labels to organize sentences from a transcript, the aspect-based summary system is able to generate aspect-based summaries that organize content from the transcript based on topic or aspect. Thus, regardless of the ordering of the transcript itself, the aspect-based summary system is able to generate comprehensive and organized summaries of even very disorganized or sporadic meetings. Accordingly, the flexible approach of the aspect-based summary system allows accurate summaries for any transcript or document.

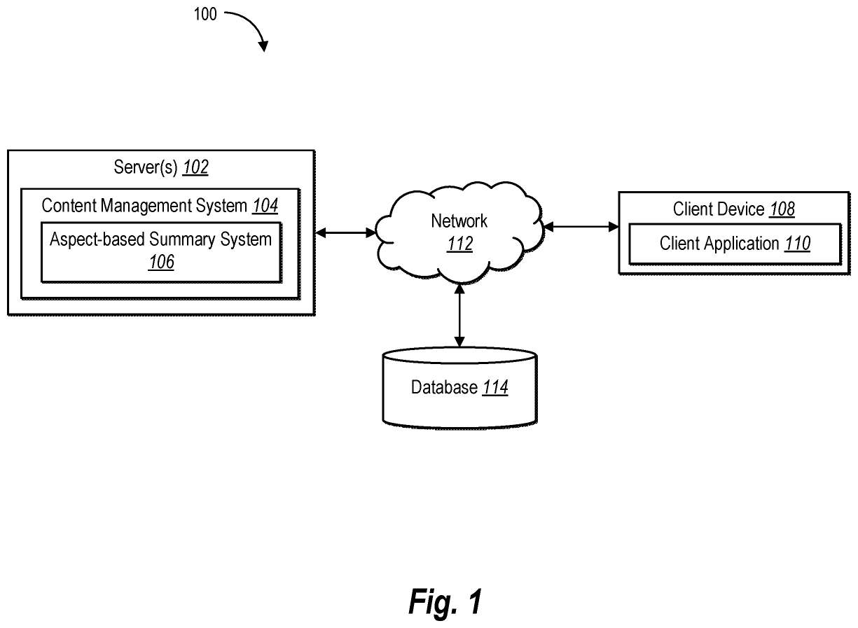

Additional detail will now be provided in relation to illustrative figures portraying example embodiments and implementations of the persona group system. For example, FIG. 1 illustrates a computing system environment (or “environment”) 100 in which an aspect-based summary system 106 operates in one or more embodiments. As illustrated in FIG. 1, the system 100 includes server(s) 102, a client device 108, a network 112, and a database 114.

Although the system 100 of FIG. 1 is depicted as having a particular number of components, the system 100 is capable of having any number of additional or alternative components (e.g., any number of servers, client devices, or other components in communication with the aspect-based summary system 106 via the network 112). Similarly, although FIG. 1 illustrates a particular arrangement of the server(s) 102, the network 112, the client device 108, and the database 114, various additional arrangements are possible.

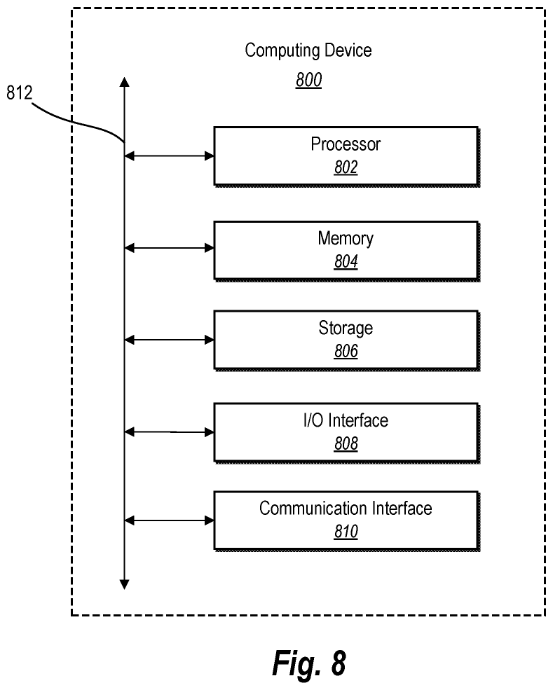

The server(s) 102, the client device 108, and the network 112 are communicatively coupled with each other either directly or indirectly (e.g., through the network 112 as discussed in greater detail below in relation to FIG. 8). Moreover, the server(s) 102 and client device 108 include one or more of a variety of computing devices (including one or more computing devices as discussed in greater detail with relation to FIG. 8).

As mentioned above, the system 100 includes the server(s) 102. In one or more embodiments, the server(s) 102 generate, store, receive, and/or transmit data including digital data related to transcripts, aspect labels, sentence organization, summaries, training data, etc. In one or more embodiments, the server(s) 102 comprise a data server. In some implementations, the server(s) 102 comprise a communication server or a web-hosting server.

In one or more embodiments, the server(s) 102 include a content management system 104. In some embodiments, the content management system 104 manages the generation, modification, storage, and/or distribution of digital content to client devices (e.g., the client device 108). For example, in some instances, the content management system 104 manages digital content related to transcripts and/or aspect-based summaries. In some implementations, the content management system 104 provides digital content for display via one or more digital platforms that are accessed by the client device 108.

Additionally, in one or more embodiments, the client devices 108 include computing devices that access digital platforms and/or display digital content. For example, the client device 108 include smartphones, tablets, desktop computers, laptop computers, head-mounted-display devices, or other electronic devices. The client devices 108 include one or more applications (e.g., the client application 110) that access digital platforms and/or display digital content. For example, in one or more embodiments, the client application 110 includes a software application installed on the client device 108. Additionally, or alternatively, the client application 110 includes a web browser or other application that accesses a software application hosted on the server(s) 102 (and supported by the content management system 104).

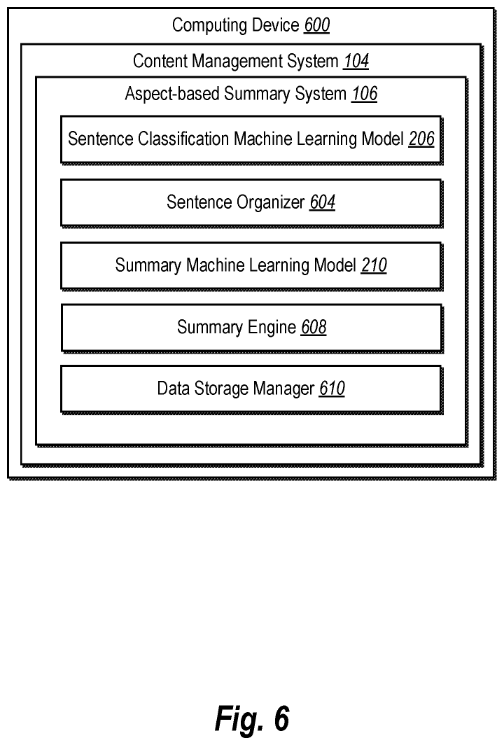

The aspect-based summary system 106 is able to be implemented in whole, or in part, by the individual elements of the system 100. Indeed, although FIG. 1 illustrates the aspect-based summary system 106 implemented with regard to the server(s) 102 and, optionally, the client device 108, different components of the aspect-based summary system 106 are able to be implemented by a variety of devices within the system 100. For example, in some cases, one or more (or all) components of the aspect-based summary system 106 are implemented by a different computing device (e.g., the client device 108) or a separate server from the server(s) 102 hosting the content management system 104. Indeed, in one or more embodiments, the client device 108 includes the aspect-based summary system 106. Example components of the aspect-based summary system 106 will be described below (e.g., with regard to FIG. 6).

To provide an example implementation, in some embodiments, the aspect-based summary system 106 on the server(s) 102 supports the client application 110 on the client device 108. For instance, in some cases, the aspect-based summary system 106 on the server(s) 102 generates or learns parameters for one or more machine learning models (e.g., the sentence classification machine learning model and the summary machine learning model). The aspect-based summary system 106 then, via the server(s) 102, provides the trained sentence classification machine learning model and the trained summary machine learning model to the client device 108. In other words, the client device 108 obtains (e.g., downloads) the sentence classification machine learning model and the summary machine learning model (e.g., with any learned parameters) from the server(s) 102. Once downloaded, the client application 110 on the client device 108 utilizes the sentence classification machine learning model and the summary machine learning model to generate aspect-based summaries from digital transcripts from the server(s) 102.

In alternative implementations, the aspect-based summary system 106 includes a web hosting application that allows the client device 108 to interact with content and services hosted on the server(s) 102. To illustrate, in one or more implementations, the client device 108 accesses a software application supported by the server(s) 102. The client device 108 provides input to the server(s) 102, such as a digital transcript. In response, the aspect-based summary system 106 on the server(s) 102 generates an aspect-based summary of the transcript. The server(s) 102 then provides the aspect-based summary to the client device 108 for display.

As also shown in FIG. 1, the system 100 includes the database 114. In one or more embodiments, the aspect-based summary system utilizes the database 114 to access a database of meeting transcripts and corresponding summaries. To illustrate, in one or more embodiments, the aspect-based summary system extracts data from the database 114.

As discussed above, in one or more embodiments, the aspect-based summary system generates aspect-based summaries of digital documents, like transcripts. A digital document refers to a document that includes text. In one or more implementations, the text in the document is organized into sentences and paragraphs. A transcript is a document that includes a written version of a spoken language. For example, a transcript is a written transcription of a meeting, a multi-party conversation, a pod cast, etc.

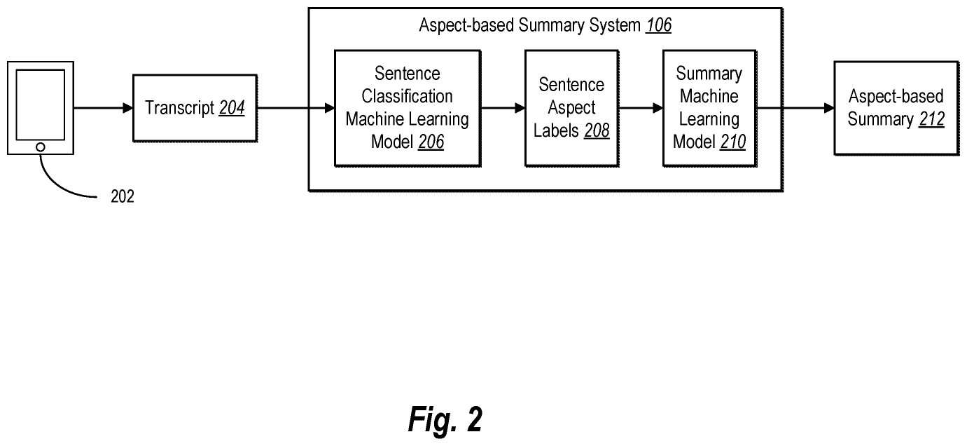

FIG. 2 illustrates an overview of the aspect-based summary system generating aspect-based summaries. More specifically, FIG. 2 illustrates an aspect-based summary system receiving a transcript 204 from a client device 202 and generating an aspect-based summary 212. In one or more embodiments, the aspect-based summary system 106 receives the transcript 204 from the client device 202. In one or more embodiments, the transcript 204 is a digital document. In some embodiments, the transcript 204 is a written transcription of verbal communication, such as a recorded meeting or conference. Additionally, in one or more embodiments, the transcript 204 includes a stream of text, unedited, and otherwise unorganized text from a meeting.

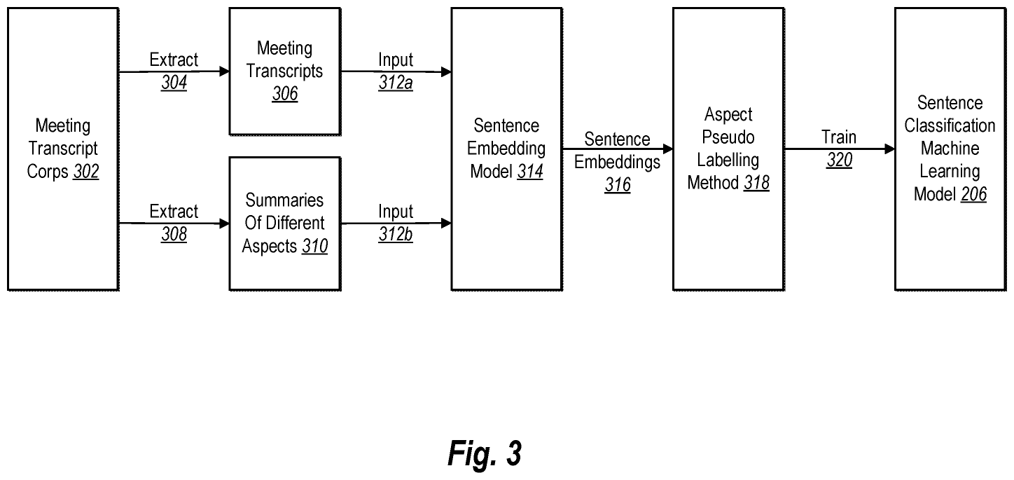

As shown in FIG. 2, in one or more embodiments, the aspect-based summary system 106 provides the transcript 204 to a sentence classification machine learning model 206. In one or more embodiments, the sentence classification machine learning model 206 is a trained multi-label classifier. As will be discussed below with regard to FIG. 3, in one or more embodiments, the aspect-based summary system 106 generates and trains the sentence classification machine learning model 206 utilizing a pseudo-labeled sentence classification training dataset. In some embodiments, the aspect-based summary system 106 generates the training dataset utilizing language embedding models.

In one or more embodiments, the sentence classification machine learning model 206 generates sentence aspect labels 208 for each sentence in the transcript 204. To illustrate, in one or more embodiments, the sentence aspect labels 208 are digital labels that the aspect-based summary system 106 applies to the sentences. In some embodiments, the sentence aspect labels 208 are metadata tags associated with the sentences. In one or more implementations, the sentence classification machine learning model 206 generates one or more aspect label for each sentence from the transcript 204. An aspect label refers to a classification or tag indicating a topic. In particular, an aspect label, in one or more implementations, is a metadata tag indicating a category or subject matter of a sentence or paragraph.

Further, in some embodiments, the aspect-based summary system 106 provides the sentence aspect labels to a summary machine learning model 210. In one or more embodiments, the aspect-based summary system 106 prepares the sentences by merging sentences with the same aspect label utilizing a token. The aspect-based summary system 106 utilizes the organized, merged sentences as input for the summary machine learning model 210. Accordingly, in one or more embodiments, the summary machine learning model 210 generates a summary corresponding to each aspect label. A summary refers to a brief statement or recounting of key details from a larger document or discussion. To illustrate, a summary includes text that synopsizes another document or transcript. Relatedly, an aspect-based summary includes a document that synopsizes a transcript that is organized based on topics from the transcript.

Accordingly, in one or more embodiments, the aspect-based summary system 106 generates an aspect-based summary 212. In one or more embodiments, the aspect-based summary system 106 generates the aspect-based summary 212 by generating a digital document with a summary for each identified aspect label. To illustrate, in some embodiments, the aspect-based summary system 106 generates headings for each aspect label and inserts the aspect-based summary corresponding to that aspect label into the document below the heading. Thus, in some embodiments, the aspect-based summary system 106 provides a single document summarizing the transcript 204 to various client devices.

As mentioned above, in one or more embodiments, the aspect-based summary system 106 trains a sentence classification machine learning model to generate aspect labels for sentences from a transcript. FIG. 3 illustrates a process for training a weakly supervised multi-label sentence classification machine learning model utilizing pseudo-labelled training dataset. Further, FIG. 3 illustrates a process for generating the pseudo-labelled training dataset.

As shown in FIG. 3, in one or more embodiments, the aspect-based summary system 106 accesses a meeting transcript corpus 302. More specifically, in some embodiments, the meeting transcript corpus 302 includes a transcript database. In some embodiments, the aspect-based summary system 106 extracts transcripts and manually annotated summaries from the meeting transcript corpus 302. For each transcript, the aspect-based summary system 106 saves the transcript with a data link to corresponding summaries.

In one or more embodiments, the aspect-based summary system 106 performs an act 304 of extracting meeting transcripts 306. Further, the aspect-based summary system 106 performs an act 308 of extracting summaries of different aspects 310. To illustrate, in some embodiments, the aspect-based summary system 106 saves the extracted transcript and summaries as a dictionary on a json file.

In one or more embodiments, the extracted transcripts and corresponding summaries include sentences related to different aspects mingled together. To address this mingling, in some embodiments, the aspect-based summary system 106 selects sentences related to each aspect utilizing a language embedding model. As shown in FIG. 3, in one or more embodiments, the aspect-based summary system 106 performs acts 312a-b of inputting the meeting transcripts 306 and the summaries of different aspects 310 into a language embedding model 314 to generate sentence embeddings 316.

To illustrate, in one or more embodiments, the aspect-based summary system 106 utilizes rich semantics learned for each sentence from a transcript to distinguish labels for each sentence. In some embodiments, the language embedding model 314 is a computer algorithm or model that generates embeddings associated with text. In particular, a language embedding model refers to a computer algorithm that analyzes text (e.g., a word or a grouping of words, such as a text phrase) and generates one or more corresponding embeddings in an embedding space. For example, a language embedding model, in one or more implementations, includes algorithms, such as the Global Vectors for Word Representation (GloVe) model or the Embeddings from Language Model (ELMo) model. In one or more implementations, the language embedding model 314 is a transformer-based model, such as the Bidirectional Encoder Representations from Transformers (BERT) model. In one or more embodiments, the language embedding model 314 comprises sentence transformers as described by Reiners et al. in Sentence-BERT: Sentence Embeddings using Siamese BERT-Networks, 2019 Conference on Empirical Methods in Natural Language Processing, available at https://arxiv.org/pdf/1908.10084.pdf, (2019), the entire content of which is hereby incorporated by reference in its entirety. Alternatively, the language embedding model 314 comprises sentence transformers as described by Jacob Devlin et al., BERT: Pre-training of Deep Bidirectional Transformers for Language Understanding, 2018, https://arxiv.org/abs/1810.04805, which is incorporated herein by reference in its entirety. In still further embodiments, the language embedding model 314 comprises sentence transformers described by SimCSE-BERT_{base} and/or SimCSE-ROBERTa_{large} as described by Gao et al. in SimCSE: Simple Contrastive Learning of Sentence Embeddings, In Proceedings of the 2021 Conference on Empirical Methods in Natural Language Processing, pages 6894-6910, Online and Punta Cana, Dominican Republic. Association for Computational Linguistics, 2021, which is incorporated herein by reference in its entirety.

In one or more embodiments, the aspect-based summary system 106 uses the language embedding model 314 to learn representation for each sentence in the extracted transcripts and their corresponding summaries. Accordingly, the language embedding model 314 generates the sentence embeddings 316. To illustrate, in one or more embodiments, the aspect-based summary system 106 distinguishes sentences relative to different aspects using sentence embeddings from the language embedding model.

Further, as shown in FIG. 3, in one or more embodiments, the aspect-based summary system 106 utilizes the sentence embeddings 316 in an aspect pseudo-labelling method 318 to generate a training dataset. To illustrate, the aspect-based summary system 106 can utilize the sentence embeddings to generate pseudo-labels of aspects for each of the sentences from the extracted transcripts. Further, the aspect-based summary system 106 uses pseudo-labels as a training dataset for the sentence classification machine learning model. Thus, the aspect-based summary system 106 utilizes the aspect pseudo-labelling method 318 to generate training labels for a training dataset.

More specifically, in one or more implementations, the aspect-based summary system 106 utilizes Algorithm 1 below to generate these pseudo-labels. To illustrate, the aspect-based summary system 106 inputs sentence embeddings from the language embedding models and utilizes a threshold α. The aspect-based summary system 106 generates aspect labels for each of the sentences. Assuming that the meeting transcript is denoted as T=(w₁, w₂, . . . , w_{L}), L is the length of the meeting transcript, the aspects for the meeting are denoted as A=(a₁, a₂, . . . , aₘ), m is the number of aspects which exist in the meeting, and summaries for the corresponding aspects are denoted as S=(S₁, S₂, . . . , Sₘ), where each of the summaries have different lengths of tokens.

Algorithm 1: Aspect labelling method for a meeting transcript
1: Let SentWithLabels=[ ].
2: for each sent S in Sents do
3: Set all aspect-labels Sₐ₁, Sₐ₂, . . . , Sₐₘ as zeros.
4: for aspect ai in all aspects do
5: Calculate semantic similarity Sim; between the embedding of S and ai.
6: if Simᵢ>α then
7: Set Sₐᵢ=1.
8: end if
9: end for
10: Add S into SentsWithLabels.
11: end for
12: return SentsWithLabels

Upon generating the pseudo-labels for the sentences in the meeting transcripts, the aspect-based summary system 106 performs an act 320 of training a sentence classification machine learning model 206. More specifically, in one or more embodiments, generates the training set by associating sentences from the extracted transcripts with their corresponding pseudo-labels generated utilizing Algorithm 1. Further, the aspect-based summary system 106 utilizes these training sentences with their corresponding pseudo-labels as ground-truth aspect labels for training the sentence classification machine learning model 206.

More specifically, in some embodiments, the aspect-based summary system 106 generates a large training dataset of dialogue with pseudo-labelling (e.g., 80,000 pseudo-labelled sentences). In one or more embodiments, the aspect-based summary system 106 splits the training dataset of dialogue with pseudo-labelling into train, validation, and test sets for training and evaluating the sentence classification machine learning model 206.

In one or more embodiments, the sentence classification machine learning model 206 comprises a machine learning model in the form of a neural network. In one or more embodiments, a neural network includes a type of machine learning model, which can be tuned (e.g., trained) based on inputs to approximate unknown functions used for generating the corresponding outputs. In particular, in some embodiments, a neural network includes a model of interconnected artificial neurons (e.g., organized in layers) that communicate and learn to approximate complex functions and generate outputs based on a plurality of inputs provided to the model. In some instances, a neural network includes one or more machine learning algorithms. Further, in some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial neural network, a graph neural network, a multi-layer perceptron, a transformer-based network, or a diffusion neural network. In some embodiments, a neural network includes a combination of neural networks or neural network components.

For example, in one or more implementations, the sentence classification machine learning model 206 includes a multi-label classifier on top of a BERT-based model to facilitate identification of sentences related to various aspects. More specifically, the sentence classification machine learning model 206 uses BERT-base as the backbone with an added dropout layer and an added linear layer. The sentence classification machine learning model 206 utilizes sigmoid activation to produce a probability of relevance of the current sentence with regard to various aspect labels. Accordingly, the sentence classification machine learning model 206 can determine whether a sentence is relevant to a specific aspect label and/or several aspect labels.

In one or more embodiments, the aspect-based summary system 106 inputs the training sentences into the sentence classification machine learning model 206. Based on the training sentences, the sentence classification machine learning model 206 generates predicted aspect labels. Further, the aspect-based summary system 106 compares the predicted aspect labels to the ground-truth aspect labels utilizing a loss function (e.g., binary cross entropy). Based on this comparison using a loss function, the aspect-based summary system 106 generates a loss. Accordingly, the aspect-based summary system 106 utilizes the loss to adjust various parameters and/or weights of the sentence classification machine learning model 206. Thus, the aspect-based summary system 106 iteratively improves the quality and accuracy of predicted aspect labels based on the loss from the loss function.

Accordingly, when the aspect-based summary system 106 has improved the accuracy of the sentence classification machine learning model 206 to a threshold accuracy, the aspect-based summary system 106 generates a trained sentence classification machine learning model. That is, in one or more embodiments, the aspect-based summary system 106 performs sufficient training iterations on the sentence classification machine learning model 206 to bring accuracy to satisfy a threshold.

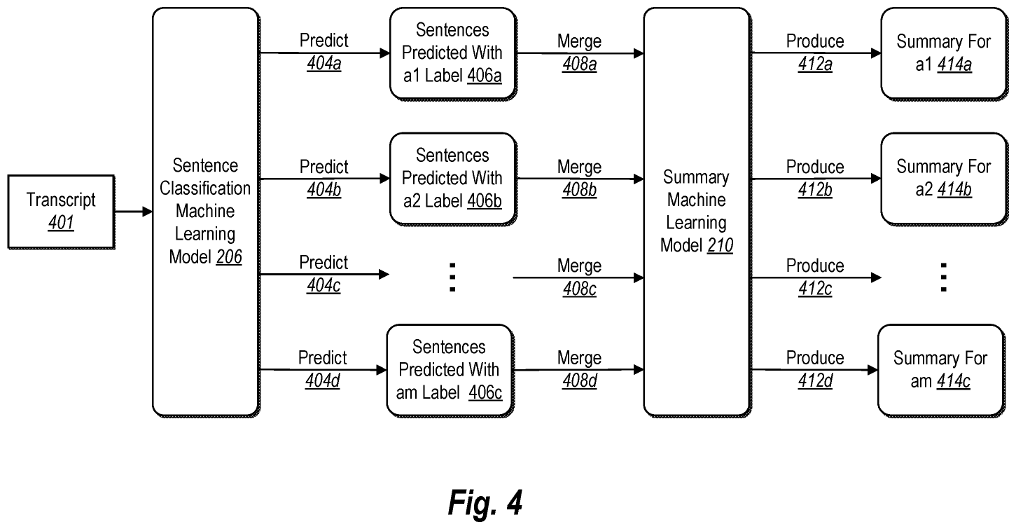

As mentioned above, the aspect-based summary system 106 utilizes a sentence classification machine learning model and a summary machine learning model to generate aspect-based summaries for transcripts. FIG. 4 illustrates a method of utilizing a trained sentence classification machine learning model 206 and a summary machine learning model to generate summaries for each aspect of a transcript.

As shown in FIG. 4, in some embodiments, the aspect-based summary system 106 provides a transcript 401 to a trained sentence classification machine learning model 206. Accordingly, in one or more embodiments, the trained sentence classification machine learning model 206 includes a multi-label classifier on top of a BERT-based model. As shown in FIG. 4, the trained sentence classification machine learning model 206 performs steps 404a-d of predicting sentences. In particular, the trained sentence classification machine learning model 206 predicts for each sentence a probability that the sentence corresponds with an aspect of a plurality of aspects. The aspect-based summary system 106 associates an aspect label with each sentence that has a probability of being associated with the aspect label over a threshold probability. In one or more implementations, the trained sentence classification machine learning model 206 associates more than one aspect label with a given sentence based on the given sentence having a probability of being associated with multiple aspect labels over the threshold probability. Still further, in one or more implementations, the trained sentence classification machine learning model 206 does not associate an aspect label with sentences that fail to have any probabilities over the threshold probability.

The trained sentence classification machine learning model 206 associates sentences from the transcript 401 with a corresponding aspect label. That is, the trained sentence classification machine learning model 206 generates groups of sentences with corresponding aspect labels. To illustrate, the trained sentence classification machine learning model 206 generates sentences with predicted a₁ labels 406a, sentences predicted with a₂ labels 406b, and sentences with aₘ label 406c, where m is the number of aspect labels identified for the transcript 401.

As also shown in FIG. 4, the aspect-based summary system 106 performs acts 408a-d of merging sentences having the same aspect label. Further, in some embodiments, the aspect-based summary system 106 generates a copy of the transcript for each aspect label, including only sentences with that aspect label. In one or more embodiments, the aspect-based summary system 106 groups of sentences with the same aspect label and merges them together in the original order of appearance in the transcript 401.

In some embodiments, the aspect-based summary system 106 generates an aspect token for each determined aspect label and utilizes the aspect tokens to merge sentences in each aspect-label sentence group. In one or more embodiments, the aspect-based summary system 106 further provides these aspect tokens to the summary machine learning model to provide an indicator of the aspect label to facilitate summary generation.

In some embodiments, the summary machine learning model 210 is a pre-trained sequence to sequence model. In addition, or in the alternative, the aspect-based summary system 106 can train the summary machine learning model 210. In one or more embodiments, the aspect-based summary system 106 generates a training dataset by preparing a dataset of aspect-labelled merged sentences and corresponding aspect tokens. Further, as mentioned above with regard to FIG. 3, the aspect-based summary system 106 extracts transcripts with corresponding summaries from a transcript database. The aspect-based summary system 106 associates these corresponding summaries with the merged sentences and corresponding aspect tokens and utilize the summaries as ground-truth data.

Similar to discussion above with regard to the sentence classification machine learning model, the aspect-based summary system 106 trains the summary machine learning model 210. In one or more embodiments, the aspect-based summary system 106 inputs the training merged aspect-labelled sentence groups into the summary machine learning model 210. Based on the merged aspect-labelled sentence groups, the summary machine learning model 210 generates predicted summaries. Further, the aspect-based summary system 106 compares the predicted summaries to the ground-truth summaries utilizing a loss function (e.g., binary cross entropy). Based on this comparison using a loss function, the aspect-based summary system 106 generates a loss. Accordingly, the aspect-based summary system 106 utilizes the loss to adjust various parameters and/or weights of the summary machine learning model 210. Thus, the aspect-based summary system 106 iteratively improves the quality and accuracy of predicted summaries based on the loss from the loss function.

Accordingly, when the aspect-based summary system 106 has improved the accuracy of the summary machine learning model 210 to a threshold accuracy, the aspect-based summary system 106 generates a trained summary machine learning model 210. That is, in one or more embodiments, the aspect-based summary system 106 performs sufficient training iterations on the summary machine learning model 210 to bring accuracy to satisfy a threshold.

As shown in FIG. 4, the aspect-based summary system 106 provides the merged sentences to the summary machine learning model 210. Further, the summary machine learning model 210 performs an act 412a-d of producing aspect-based summaries for each aspect label. More specifically, the summary machine learning model 210 generates a summary for a₁ 414a, a summary for a₂ 414b, and summary for aₘ 414c, where a₁-aₘ are aspect labels, and m is the number of aspect labels identified for the transcript 401. By utilizing the aspect-labelled merged sentences and the aspect token to generate aspect-based summaries, the summary machine learning model 210 generates summaries with improved accuracy.

More specifically, the aspect-based summary system 106 generates, utilizing the summary machine learning model 210, a summary of the transcript for each aspect of the plurality of aspects from the organized sentences. For example, the aspect-based summary system 106 generates a first summary, utilizing the summary machine learning model 210, for a first aspect based on a first subset of the sentences from the transcript associated with a first aspect label. The aspect-based summary system 106 generates a second summary, utilizing the summary machine learning model 210, for a second aspect based on a second subset of the sentences from the transcript associated with a second aspect label.

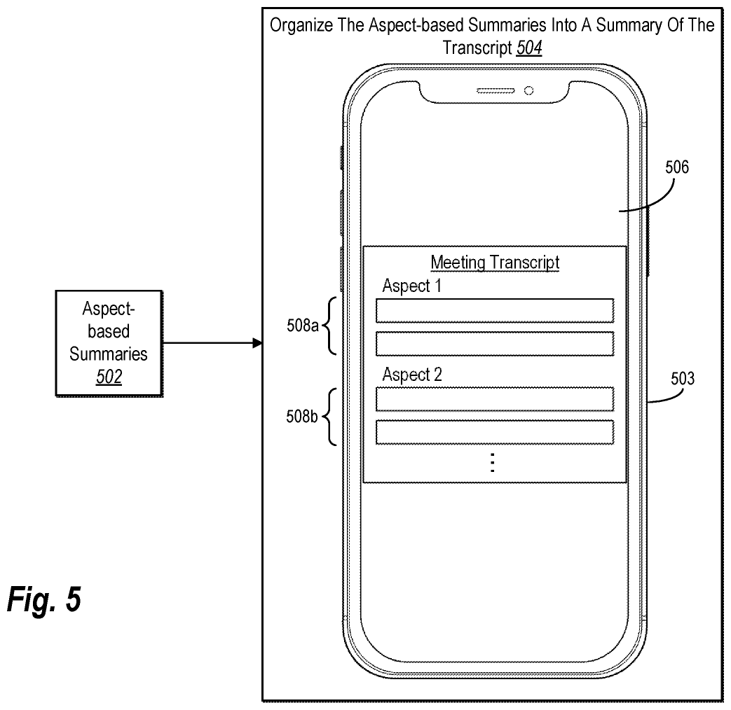

Additionally, as mentioned above, because the summary machine learning model 210 generates summaries for each aspect label, the aspect-based summary system 106 can utilize these summaries to generate an aspect-based summary for the transcript. FIG. 5 illustrates a process for generating a single document including an aspect-based summary for each aspect label from a transcript. As shown in FIG. 5, the aspect-based summary system 106 utilizes aspect-based summaries 502 to perform an act 504 of organizing the aspect-based summaries into a summary of the transcript.

To illustrate, FIG. 5 shows a user interface 503, generated by the aspect-based summary system 106, presenting an aspect-based summary 506. In one or more embodiments, the aspect-based summary system 106 generates a title for the document based on the title of a transcript. Further, the aspect-based summary system 106 generates headings for each aspect label and inserts the summary corresponding to that aspect label below the heading. As shown in FIG. 5, the aspect-based summary 506 includes sections 508a-b for aspect labels found in the original transcript. It will be appreciated, however, that the aspect-based summary system 106 can generate an aspect-based summary having a variety of number of aspect headings, based on the number of aspect labels relevant to a transcript.

In one or more embodiments, the aspect-based summary system 106 provides an aspect-based summary to various client devices. In addition, or in the alternative, the aspect-based summary system 106 provides an aspect-based summary to a content management system. In turn, in one or more embodiments, the content management system distributes aspect-based summaries to various client devices.

As mentioned above, the aspect-based summary system 106 provides a single system (e.g., a single sentence classification model 206 together with a single summary machine learning model 210) that produces a plurality of summaries for a given transcript. In particular, the aspect-based summary system 106 generates a summary for each aspect in a transcript. This contrasts with conventional systems that require a separate model/system trained for each topic. Thus, the aspect-based summary system 106 is more efficient than conventional systems because a single pipeline (e.g., a single sentence classification model 206 together with a single summary machine learning model 210) produces a plurality of summaries rather than having to use multiple different pipelines to obtain a similar result. Thus, the aspect-based summary system 106 utilizes fewer computing resources (storage and processing power) than conventional systems to generate the same type of result (e.g., multiple summaries for different topics/aspects in a document).

In addition to being more efficient, the aspect-based summary system 106 is also more accurate than conventional systems. Researchers utilized ROURGE F₁ scores (see Lin, ROUGE: A package for automatic evaluation of summaries, In Text Summarization Branches Out, pages 74-81, Barcelona, Spain, Association for Computational Linguistics 2004), which include the overlap of unigrams (R−1), bigrams (R−2), and longest common subsequence (R−L) to evaluate the performance of different summarization models. The researchers compared aspect-based summary system 106 with recent state of the art pretrained language models including TextRank (Mihalcea et al., TextRank: Bringing order into text, In Proceedings of the conference on empirical methods in natural language processing, pages 404-411, 2004), LexRank (Erkan et al., LexRank: Graph-Based Lexical Centrality As Salience In Text Summarization, Journal of Artificial Intelligence Research, 22:457-479, 2004), T5 (Raffel et al., Exploring The Limits Of Transfer Learning With A Unified Text-To-Text Transformer, J. Mach. Learn. Res., 21(140):1-67, 2020), LED (Beltagy et al., Longformer: The Long-Document Transformer, arXiv preprint arXiv:2004.05150, 2020), and BART (Lewis et al., BART: Denoising Sequence-To-Sequence Pre-Training For Natural Language Generation, Translation, and Comprehension, In Proceedings of the 58th Annual Meeting of the Association for Computational Linguistics, pages 7871-7880, Online, Association for Computational Linguistics, 2020).

Table 1 shows the experimental results of the aspect-based summary system 106 and the comparison models mentioned above. The researchers trained the same baseline model for each of the aspects and used the results obtained from the separate models for each aspect. For example, for the baseline BARTlarge, the researched used the same model architecture to train three different models, each of which is trained for producing the corresponding aspect-based summary. As mentioned above, the aspect-based summary system 106 is one single summarizer which is trained for producing summaries for all aspects. Table 1 shows that the aspect-based summary system 106 performs much better than all the comparison models on the three aspects of Problem, Action, and Decision. The better performance of the aspect-based summary system 106 verifies that the two-stage approach is able to select the most informative sentences for different aspects in the meeting, which helps improve the performance of aspect-based summary generation for meeting transcript.

TABLE 1

| | Problem | | | Action | | | Decision | | |
|---|---|---|---|---|---|---|---|---|---|
| Models | R-1 | R-2 | R-L | R-1 | R-2 | R-L | R-1 | R-2 | R-L |
| TextRank | 16.44 | 1.68 | 9.25 | 13.24 | 2.67 | 9.57 | 21.19 | 1.59 | 13.36 |
| LexRank | 16.92 | 2.24 | 9.39 | 9.03 | 2.27 | 6.53 | 21.77 | 2.33 | 13.22 |
| T5_{base} | 8.66 | 1.30 | 6.33 | 22.01 | 3.76 | 17.59 | 20.59 | 6.35 | 19.03 |
| T5_{large} | 5.40 | 0.20 | 3.95 | 20.66 | 5.57 | 18.04 | 21.12 | 6.29 | 19.78 |
| LED_{base} | 4.76 | 0.00 | 4.76 | 13.92 | 5.48 | 12.39 | 18.19 | 6.71 | 17.69 |
| BART_{base} | 4.76 | 0.00 | 4.76 | 21.05 | 0.00 | 21.05 | 10.83 | 2.39 | 8.53 |
| BART_{large} | 6.03 | 0.00 | 5.71 | 21.05 | 0.00 | 21.05 | 24.93 | 11.72 | 20.88 |
| System 106 | 21.19 | 8.25 | 16.14 | 22.39 | 7.84 | 18.97 | 31.47 | 11.20 | 23.67 |

Turning to FIG. 6, each of the components of the aspect-based summary system 106 include software, hardware, or both. For example, the components include one or more instructions stored on a computer-readable storage medium and executable by processors of one or more computing devices, such as a client device or server device. When executed by the one or more processors, the computer-executable instructions of the aspect-based summary system 106 cause the one or more processors to perform the methods described herein. Alternatively, the components include hardware, such as a special-purpose processing device to perform a certain function or group of functions. Alternatively, the components of the aspect-based summary system 106 include a combination of computer-executable instructions and hardware.

Furthermore, the components of the aspect-based summary system 106, for example, are implemented as one or more operating systems, as one or more stand-alone applications, as one or more modules of an application, as one or more plug-ins, as one or more library functions or functions that may be called by other applications, and/or as a cloud-computing model. Thus, the components are implemented, in one or more implementations, as a stand-alone application, such as a desktop or mobile application. Furthermore, the components of the aspect-based summary system 106, in one or more implementations, are implemented as one or more web-based applications hosted on a remote server. The components of the aspect-based summary system 106 may also be implemented in a suite of mobile device applications or “apps.”

As shown in FIG. 6, the content management system 104 and the aspect-based summary system 106 are implemented via a computing device 600. In one or more embodiments, the aspect-based summary system 106 includes a sentence classification machine learning model 206. In one or more embodiments, the sentence classification machine learning model 206 generates aspect labels for the sentences of a transcript. In some embodiments, the sentence classification machine learning model 206 determines aspect labels corresponding to an aspect, topic, or classification for the sentence.

Further, in some embodiments, the aspect-based summary system 106 includes a sentence organizer 604. In one or more embodiments, the sentence organizer 604 groups sentences having the same aspect label. Further, in some embodiments, the sentence organizer 604 merges these groupings of sentences together utilizing an aspect token. Accordingly, in one or more embodiments, the sentence organizer 604 provides the organized sentences to the summary machine learning model 210.

Additionally, in one or more embodiments, the aspect-based summary system 106 includes a summary machine learning model 210. In one or more embodiments, the summary machine learning model 210 generates a summary for each aspect label and/or each merged grouping of sentences from the transcript.

Also, in one or more embodiments, the aspect-based summary system 106 includes a summary engine 608. To illustrate, in some embodiments, the summary engine 608 generates an aspect-based summary document including summaries for each aspect label from a transcript. In one or more embodiments, the summary engine 608 combines the aspect summaries into a single document and orders the aspect summaries. Further, in some embodiments, the summary engine 608 provides the aspect-based summary document to client devices.

In some embodiments, the aspect-based summary system 106 further includes a data storage manager 610. The data storage manager 610 maintains data for the aspect-based summary system 106. The data storage manager 610 (e.g., via one or more memory devices) maintains data of any type, size, or kind, as necessary to perform the functions of the aspect-based summary system 106. For example, the data storage manager 610 includes aspect labels, sentences, training datasets, aspect-based summaries, etc.

To illustrate, the components may be implemented in an application, including but not limited to ADOBE® PREMIERE, ADOBE® PREMIERE PRO, ADOBE® AUDIO RECORDER, ADOBE® AUDITION, and ADOBE® PODCAST STUDIO. “ADOBE”, “ADOBE PREMIERE”, “ADOBE PREMIERE PRO”, “ADOBE AUDIO RECORDER”, “ADOBE CAMPAIGN”, “ADOBE AUDITION”, and “ADOBE PODCAST STUDIO” are either registered trademarks or trademarks of Adobe Systems Incorporated in the United States and/or other countries.”

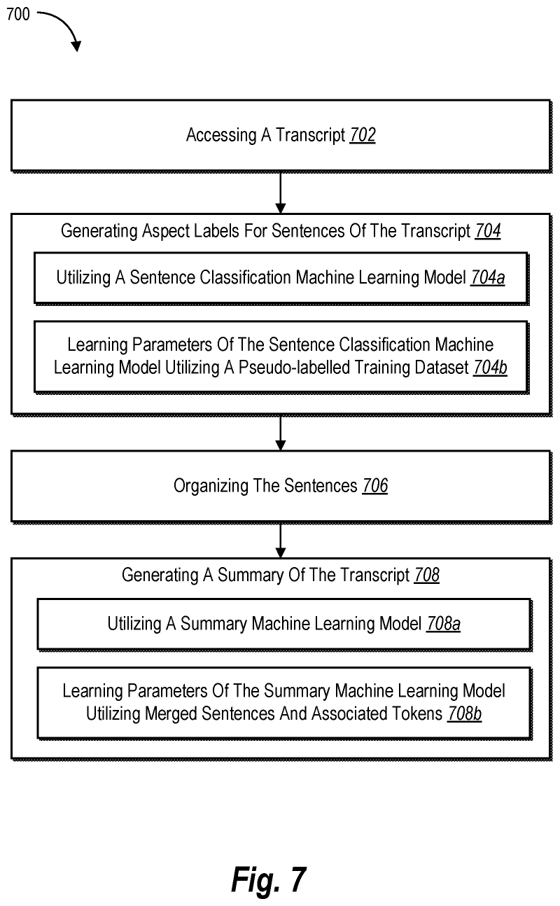

FIGS. 1-6, the corresponding text, and the examples provide a number of different methods, systems, devices, and non-transitory computer-readable media of the aspect-based summary system 106. In addition to the foregoing, one or more embodiments can also be described in terms of flowcharts comprising acts for accomplishing a particular result, as shown in FIG. 7. FIG. 7 may be performed with more or fewer acts. Further, the acts may be performed in differing orders. Additionally, the acts described herein may be repeated or performed in parallel with one another or parallel with different instances of the same or similar acts.

As mentioned, FIG. 7 illustrates a flowchart of a series of acts 700 for generating aspect-based summaries in accordance with one or more embodiments. While FIG. 7 illustrates acts according to one embodiment, alternative embodiments may omit, add to, reorder, and/or modify any of the acts shown in FIG. 7. The acts of FIG. 7, in one or more implementations, are performed as part of a method. Alternatively, a non-transitory computer-readable medium comprises instructions that, when executed by one or more processors, cause the one or more processors to perform the acts of FIG. 7. In some embodiments, a system performs the acts of FIG. 7.

As shown in FIG. 7, the series of acts 700 includes an act 702 for accessing a transcript. In one or more implementations, act 702 includes receiving a transcript comprising sentences from a client device or retrieving the transcript from a computer storage location.

Additionally, the series of acts 700 includes an act 704 for generating aspect labels for sentences of the transcript. In one or more implementations, the acts 700 include receiving user input specifying the one or more aspects. To illustrate, the act 704, in one or more implementations, includes an act 704a for utilizing a sentence classification machine learning model. Additionally, the act 704 optionally includes an act 704b of learning parameters of the sentence classification machine learning model utilizing a pseudo-labelled training dataset.

Further, in one or more embodiments, the series of acts 700 includes an act 706 of organizing sentences. For example, act 706 involves organizing the sentences based on the aspect labels. In particular, act 706 involves, in one or more implementations, merging sentences with a matching aspect label and associating a token for the aspect label with the merged sentences.

Also, in some embodiments, the series of acts 708 includes an act 708 of generating a summary of the transcript. Further, in one or more embodiments, the act 708 includes an act 708a of utilizing a summary machine learning model. In particular, act 708 includes generating, utilizing a sentence classification machine learning model, aspect labels for the sentences of the transcript. The aspect labels correspond to a plurality of aspects. Act 708 includes, in one or more implementations, predicting, for a sentence, probabilities that the sentence corresponds with each aspect of the plurality of aspects. In such implementations, act 708 involves associating an aspect label with the sentence that has a corresponding probability over a threshold probability. Additionally, the act 708 optionally includes an act 708b of learning parameters of the summary machine learning model utilizing merged sentences and associated tokens.

In one or more implementations, act 708 involves generating a first summary, utilizing the summary machine learning model, for a first aspect based on a first subset of the sentences from the transcript associated with a first aspect label for the first aspect. Similarly, act 708 involves comprises generating a second summary, utilizing the summary machine learning model, for a second aspect based on a second subset of the sentences from the transcript associated with a second aspect label for the second aspect. In one or more implementations, one or more sentences are in both the first subset of sentences and the second subset of sentences.

Additionally, in some embodiments, the series of acts 700 includes learning parameters of a sentence classification machine learning model utilizing a pseudo-labelled training dataset, generating aspect labels corresponding to the sentences utilizing the sentence classification machine learning model, merging sentences with matching sentence classifications and associating tokens corresponding to the aspect labels to the merged sentences, and learning parameters of a summary machine learning model utilizing the merged sentences and associated tokens based on target summaries.

Further, in one or more embodiments, the series of acts 700 includes wherein the sentence classification machine learning model comprises a weakly supervised multi-label classifier. Additionally, in some embodiments, the series of acts 700 includes wherein training the sentence classification machine learning model comprises utilizing a training dataset of dialogue with pseudo-labeling.

In one or more embodiments, the series of acts 700 further includes extracting, from a database of transcripts, meeting transcripts and corresponding summaries, providing the meeting transcripts and the corresponding summaries to a language embedding model to generate embeddings for sentences in the meeting transcripts, generating the aspect labels based on the embeddings utilizing a pseudo-labelling method, and aggregating the sentences and corresponding aspect labels to generate a training dataset of dialogue with pseudo-labelling.

Additionally, in some embodiments, the series of acts 700 includes inputting the training dataset of dialogue to an untrained sentence classification machine learning model, utilizing the untrained sentence classification machine learning model to identify predicted aspect labels for the training dataset of dialogue, and training the sentence classification machine learning model to select the aspect labels by comparing the predicted aspect labels to the pseudo-labelling using a loss from a loss function.

The series of acts 700 also include organizing the sentences based on the aspect labels by merging sentences with matching aspect labels utilizing an aspect token and providing the merged sentence groups to the sentence classification machine learning model to generate an aspect summary. Additionally, the series of acts 700, in one or more implementations, includes combining aspect summaries to generate the summary of the transcript and ordering the aspect summaries based on an order of appearance in the transcript.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 8 illustrates a block diagram of an example computing device 800 that may be configured to perform one or more of the processes described above. One will appreciate that one or more computing devices, such as the computing device 800 may represent the computing devices described above (e.g., computing device 600, server(s) 102, and client device 108). In one or more embodiments, the computing device 800 may be a mobile device (e.g., a mobile telephone, a smartphone, a PDA, a tablet, a laptop, a camera, a tracker, a watch, a wearable device, etc.). In some embodiments, the computing device 800 may be a non-mobile device (e.g., a desktop computer or another type of client device). Further, the computing device 800 may be a server device that includes cloud-based processing and storage capabilities.

As shown in FIG. 8, the computing device 800 can include one or more processor(s) 802, memory 804, a storage device 806, input/output interfaces 808 (or “I/O interfaces 808”), and a communication interface 810, which may be communicatively coupled by way of a communication infrastructure (e.g., bus 812). While the computing device 800 is shown in FIG. 8, the components illustrated in FIG. 8 are not intended to be limiting. Additional or alternative components may be used in other embodiments. Furthermore, in certain embodiments, the computing device 800 includes fewer components than those shown in FIG. 8. Components of the computing device 800 shown in FIG. 8 will now be described in additional detail.

In particular embodiments, the processor(s) 802 includes hardware for executing instructions, such as those making up a computer program. As an example, and not by way of limitation, to execute instructions, the processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 804 may be internal or distributed memory.

The computing device 800 includes a storage device 806 includes storage for storing data or instructions. As an example, and not by way of limitation, the storage device 806 can include a non-transitory storage medium described above. The storage device 806 may include a hard disk drive (HDD), flash memory, a Universal Serial Bus (USB) drive or a combination these or other storage devices.

As shown, the computing device 800 includes one or more I/O interfaces 808, which are provided to allow a user to provide input to (such as user strokes), receive output from, and otherwise transfer data to and from the computing device 800. These I/O interfaces 808 may include a mouse, keypad or a keyboard, a touch screen, camera, optical scanner, network interface, modem, other known I/O devices or a combination of such I/O interfaces 808. The touch screen may be activated with a stylus or a finger.

The I/O interfaces 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 808 are configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 provides one or more interfaces for communication (such as, for example, packet-based communication) between the computing device and one or more other computing devices or one or more networks. As an example, and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI. The computing device 800 can further include a bus 812. The bus 812 can include hardware, software, or both that connects components of computing device 800 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
accessing a transcript comprising sentences;
generating, utilizing a sentence classification machine learning model, aspect labels for the sentences of the transcript, wherein the aspect labels correspond to a plurality of aspects;
organizing the sentences based on the aspect labels; and
generating, utilizing a summary machine learning model, a summary of the transcript for each aspect of the plurality of aspects from the organized sentences.

2. The computer-implemented method of claim 1, wherein generating, utilizing the sentence classification machine learning model, the aspect labels for the sentences of the transcript comprises predicting, for a sentence, probabilities that the sentence corresponds with each aspect of the plurality of aspects.

3. The computer-implemented method of claim 2, further comprising associating an aspect label with the sentence that has a corresponding probability over a threshold probability.

4. The computer-implemented method of claim 1, wherein organizing the sentences based on the aspect labels comprises merging sentences with a matching aspect label and associating a token for the aspect label with the merged sentences.

5. The computer-implemented method of claim 1, wherein generating, utilizing the summary machine learning model, the summary of the transcript for each aspect of the plurality of aspects from the organized sentences comprises generating a first summary, utilizing the summary machine learning model, for a first aspect based on a first subset of the sentences from the transcript associated with a first aspect label for the first aspect.

6. The computer-implemented method of claim 1, wherein generating, utilizing the summary machine learning model, the summary of the transcript for each aspect of the plurality of aspects from the organized sentences comprises providing merged sentence groups to the sentence classification machine learning model to generate a plurality of aspect summaries.

7. The computer-implemented method of claim 6, further comprising:
combining the plurality of aspect summaries to generate the summary of the transcript; and
ordering the aspect summaries based on an order of appearance in the transcript.

8. A system comprising:
one or more memory devices comprising a transcript comprising sentences; and
one or more processors configured to cause the system to:
learn parameters of a sentence classification machine learning model utilizing a pseudo-labelled training dataset;
generate aspect labels corresponding to the sentences utilizing the sentence classification machine learning model;
merge sentences with matching sentence classifications and associating tokens corresponding to the aspect labels to the merged sentences; and
learn parameters of a summary machine learning model utilizing the merged sentences and associated tokens based on target summaries.

9. The system of claim 8, wherein the one or more processors configured to cause the system to learn parameters of the sentence classification machine learning model utilizing weak supervision.

10. The system of claim 8, wherein the one or more processors configured to cause the system to learn parameters of the sentence classification machine learning model utilizing a training dataset of dialogue with pseudo-labeling.

11. The system of claim 8, wherein the one or more processors are further configured to cause the system to:
extract, from a database of transcripts, meeting transcripts and corresponding summaries;
provide the meeting transcripts and the corresponding summaries to a language embedding model to generate embeddings for sentences in the meeting transcripts;
generate the aspect labels based on the embeddings utilizing a pseudo-labelling method; and
aggregate the sentences and corresponding aspect labels to generate a training dataset of dialogue with pseudo-labelling.

12. The system of claim 11, wherein the one or more processors are further configured to cause the system to:
input the training dataset of dialogue to a sentence classification machine learning model;
utilize the sentence classification machine learning model to identify predicted aspect labels for the training dataset of dialogue; and
update the sentence classification machine learning model to select the aspect labels by comparing the predicted aspect labels to the pseudo-labelling using a loss from a loss function.

13. The system of claim 8, wherein the one or more processors are further configured to cause the system to:
organize the sentences based on the aspect labels by merging sentences with matching aspect labels utilizing aspect tokens into merged sentence groups; and
provide the merged sentence groups to the sentence classification machine learning model to generate an aspect summary.

14. The system of claim 8, wherein the one or more processors are further configured to cause the system to:
combine aspect summaries to generate a summary of the transcript; and
order the aspect summaries based on an order of appearance in the transcript.

15. A non-transitory computer readable medium storing executable instructions which, when executed by a processing device, cause the processing device to perform operations comprising:
receiving a transcript comprising sentences;
generating, utilizing a sentence classification machine learning model, aspect labels for the sentences of the transcript, wherein the aspect labels correspond to a plurality of aspects;
organizing the sentences based on the aspect labels; and
generating, utilizing a summary machine learning model, a summary of the transcript for each aspect of the plurality of aspects from the organized sentences.

16. The non-transitory computer readable medium of claim 15, wherein generating, utilizing the sentence classification machine learning model, the aspect labels for the sentences of the transcript comprises utilizing a weakly supervised sentence classification machine learning model trained with a training dataset of dialogue with pseudo-labeling.

17. The non-transitory computer readable medium of claim 15, wherein generating, utilizing the summary machine learning model, the summary of the transcript for each aspect of the plurality of aspects from the organized sentences comprises generating a first summary of the transcript for a first aspect and generating a second summary of the transcript for a second aspect.

18. The non-transitory computer readable medium of claim 17, generating, utilizing the summary machine learning model, the summary of the transcript for each aspect of the plurality of aspects from the organized sentences comprises:
generating the first summary, utilizing the summary machine learning model, for the first aspect based on a first subset of the sentences from the transcript associated with a first aspect label for the first aspect; and
generating the second summary, utilizing the summary machine learning model, for the second aspect based on a second subset of the sentences from the transcript associated with a second aspect label for the second aspect.

19. The non-transitory computer readable medium of claim 15, wherein organizing the sentences based on the aspect labels comprises merging sentences with a matching aspect label and associating a token for the aspect label with the merged sentences.

20. The non-transitory computer readable medium of claim 15, wherein generating, utilizing the sentence classification machine learning model, the aspect labels for the sentences of the transcript comprises:
predicting for a sentence a probability that the sentence corresponds with an aspect of the plurality of aspects; and
associating an aspect label with each sentence that has a probability for the aspect label over a threshold probability.
